(19) United States
(12) Patent Application Publication
(10) Pub. No.: US 2025/0366602 A1
(43) Pub. Date: Dec. 4, 2025

(54) CORE ASSEMBLY, ELECTRIC TOOTHBRUSH, CONTROL METHOD AND RELEVANT DEVICE

(71) Applicant: DIMI LIFE TECHNOLOGY CO., LTD., Shenzhen, Guangdong (CN)

(72) Inventors: Fengfu LI, Shenzhen (CN); Haibing ZHOU, Shenzhen (CN); Wei HOU, Shenzhen (CN); Ning LIU, Shenzhen (CN)

(73) Assignee: DIMI LIFE TECHNOLOGY CO., LTD., Shenzhen, Guangdong (CN)

(21) Appl. No.: 18/871,157

(22) PCT Filed: Sep. 22, 2023
(86) PCT No.: PCT/CN2023/120669

§ 371 Date: Dec. 3, 2024

(30) Foreign Application Priority Data
Feb. 24, 2023 (CN) 202320400659.0

(51) Int. Cl. A46B 13/04; A46B 13/02; A46B 15/00; A61C 17/22; A61C 17/34

(52) U.S. Cl. CPC A46B 13/04; A46B 13/023; A46B 15/0004; A46B 15/0044; A61C 17/221; A61C 17/224; A61C 17/227; A61C 17/3481; A61C 2204/002; A61C 2204/005

(57) ABSTRACT

The present disclosure provides a core assembly, an electric toothbrush, a control method and a relevant device, and it relates to the field of health care technology. The core assembly includes: a motor including a hollow rotating shaft, a first end of the hollow rotating shaft being coupled to the toothbrush head; a peristaltic pump, a first end of the peristaltic pump being coupled to the toothpaste chamber, and a second end of the peristaltic pump being coupled to a second end of the hollow rotating shaft; and a control assembly electrically coupled to the peristaltic pump, and configured to control the peristaltic pump to transfer toothpaste in the toothpaste chamber through the hollow rotating shaft to the toothbrush head, the control assembly being further electrically coupled to the motor and configured to control the motor to operate so as to enable the toothbrush head to vibrate.

### CROSS-REFERENCE TO RELATED APPLICATION

This application claims a priority of the Chinese patent application No.202320400659.0 filed on Feb. 24, 2023 and entitled “electric toothbrush”, which is incorporated herein by reference in its entirety.

### TECHNICAL FIELD

The present disclosure relates to the field of health care technology, in particular to a core assembly, an electric toothbrush, a control method and a relevant device.

### BACKGROUND

As an essential daily necessity for people, a toothbrush is used for cleaning teeth, so as to keep mouth health. Along with the continuous development of electric toothbrushes, the electric toothbrush has been used by more and more people. Usually, for a conventional electric toothbrush, toothpaste is pushed through an air pump. For example, WO2023109166A1 published on Jun. 22, 2023 discloses an electric toothbrush in which the toothpaste is pushed through a pneumatic device. To be specific, a gas at a predetermined pressure is provided by an air pump to a piston in a liquid storage mechanism, so as to move the piston, thereby to push the toothpaste. Hence, an air intake structure needs to be provided for the pneumatic device. Moreover, after the toothpaste is pushed under the effect of the gas at the predetermined pressure from the pneumatic device, there is a remaining pressure in the liquid storage mechanism. When the pneumatic device stops providing the gas at the predetermined pressure, the toothpaste is extruded continuously due to the remaining pressure, so such a phenomenon as toothpaste overflow occurs. Hence, when the toothpaste is pushed through the pneumatic device, a corresponding air outtake structure needs to be further provided so as to prevent the occurrence of the toothpaste overflow. In WO2023109166A1, such structures as a gas discharge valve, a gas exchange structure, a gas discharge cover, a gas discharge hole and a waterproof gas-permeable membrane are provided, leading to a complex structure of the entire electric toothbrush.

In the conventional electric toothbrush, the toothpaste is pushed under the effect of a pressurized gas, and thereby hermeticity is highly demanded. On one hand, a manufacture process of the electric toothbrush is strictly required. On the other hand, the waterproof gas-permeable membrane easily fails due to the residual toothpaste at a top cover, so the hermeticity of the electric toothbrush is adversely affected. In the case of insufficient gas pressure, it is impossible to push the toothpaste. In addition, in the conventional electric toothbrush, bubbles occur at a toothbrush handle when the gas is discharged. For example, in WO2023109166A1, a gas discharge structure of the electric toothbrush is arranged at a top cover of the handle. When there is water or residual toothpaste at the top cover and a button is pressed to push the toothpaste, the gas at the predetermined pressure is applied by the pneumatic device to the liquid storage mechanism, so as to push the toothpaste. The gas at the predetermined pressure needs to be discharged from the top cover, and at this time, the bubbles occur at the top cover, so the user experience is adversely affected. Moreover, the air pump may be affected by attenuation, thereby it is difficult to ensure the stability of the amount of toothpaste pushed out each time. In addition, the air pump is susceptible to an air pressure, and in a plateau low-air-pressure environment, the normal use of the toothbrush is adversely affected, so the use of the electric toothbrush is limited.

Based on the above, for the conventional electric toothbrush, the toothpaste is pushed through the air pump, so it is necessary to not only provide the air intake structure, but also provide the air outtake structure so as to prevent the occurrence of the toothpaste overflow due to the remaining pressure. Hence, a core has a complex structure, the entire electric toothbrush has a too large size to carry.

### SUMMARY

An object of the present disclosure is to provide a core assembly, an electric toothbrush, a control method and a relevant device, so as to solve the problems in the related art where the electric toothbrush is uneasy to carry due to a complex structure and a large size.

In order to solve the above-mentioned problems, the present disclosure provides the following technical solutions.

In one aspect, the present disclosure provides in some embodiments a core assembly for an electric toothbrush, the electric toothbrush including a toothbrush head, a toothbrush handle and a toothpaste chamber, the core assembly including: a motor including a hollow rotating shaft, a first end of the hollow rotating shaft being coupled to the toothbrush head; a peristaltic pump, a first end of the peristaltic pump being coupled to the toothpaste chamber, and a second end of the peristaltic pump being coupled to a second end of the hollow rotating shaft; and a control assembly electrically coupled to the peristaltic pump, and configured to control the peristaltic pump to transfer toothpaste in the toothpaste chamber through the hollow rotating shaft to the toothbrush head, the control assembly being further electrically coupled to the motor and configured to control the motor to operate so as to enable the toothbrush head to vibrate.

In another aspect, the present disclosure provides in some embodiments an electric toothbrush, including a toothbrush head, a toothbrush handle, a toothpaste chamber, and the above-mentioned core assembly arranged in the toothbrush handle.

In yet another aspect, the present disclosure provides in some embodiments a control method, including: transmitting a first control instruction to a peristaltic pump, the first control instruction being used to indicate the peristaltic pump to be in a working state for a first duration so as to push toothpaste in a toothpaste chamber to a toothbrush head; and transmitting a second control instruction to a motor after the first duration, the second control instruction being used to indicate the motor to be in a working state for a second duration.

In still yet another aspect, the present disclosure provides in some embodiments a control device, including: a first transmission module configured to transmit a first control instruction to a peristaltic pump, the first control instruction being used to indicate the peristaltic pump to be in a working state for a first duration so as to push toothpaste in a toothpaste chamber to a toothbrush head; and a second transmission module configured to transmit a second control instruction to a motor after the first duration, the second control instruction being used to indicate the motor to be in a working state for a second duration.

In still yet another aspect, the present disclosure provides in some embodiments an electronic device, including a memory, a processor, and a program stored in the memory and executed by the processor. The processor is configured to read the program in the memory so as to implement the steps in the above-mentioned control method.

In still yet another aspect, the present disclosure provides in some embodiments a readable storage medium storing therein a program. The program is executed by a processor so as to implement the steps in the above-mentioned control method.

According to the embodiments of the present disclosure, the core assembly includes the motor, the peristaltic pump and the control assembly, and the motor includes the hollow rotating shaft. As an essential structure of a power unit (the motor), the rotating shaft is designed as hollow, i.e., a passage for the delivery of the toothpaste is formed in the rotating shaft. When the hollow rotating shaft of the motor serves as the passage for the delivery of the toothpaste, it is able to reduce the quantity of components desired for the core assembly, and reduce a size of the core assembly as well as a space occupied by the core assembly in the electric toothbrush, thereby to reduce a size of the entire electric toothbrush and achieve a lightweight design of the electric toothbrush.

### BRIEF DESCRIPTION OF THE DRAWINGS

FIG. 1 is a schematic view showing a core assembly according to one embodiment of the present disclosure;

FIG. 2 is a schematic view showing an electric toothbrush according to one embodiment of the present disclosure;

FIG. 3 is an exploded view of the electric toothbrush according to one embodiment of the present disclosure;

FIG. 4a is a schematic view showing a toothpaste chamber according to one embodiment of the present disclosure;

FIG. 4b is another schematic view showing the toothpaste chamber according to one embodiment of the present disclosure;

FIG. 4c is yet another schematic view showing the toothpaste chamber according to one embodiment of the present disclosure;

FIG. 5 is a schematic view showing a first connection base according to one embodiment of the present disclosure;

FIG. 6 is an exploded view of the first connection base according to one embodiment of the present disclosure;

FIG. 7 is another schematic view showing the first connection base according to one embodiment of the present disclosure;

FIG. 8 is yet another schematic view showing the first connection base according to one embodiment of the present disclosure;

FIG. 9 is a schematic view showing the first connection base according to one embodiment of the present disclosure;

FIG. 10 is another schematic view showing the electric toothbrush according to one embodiment of the present disclosure;

FIG. 11 is a sectional view of the electric toothbrush according to one embodiment of the present disclosure;

FIG. 12 is a flow chart of a control method according to one embodiment of the present disclosure;

FIG. 13 is a schematic view showing a control module according to one embodiment of the present disclosure; and

FIG. 14 is a schematic view showing an electronic device according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. In the following description, specific details of configurations and assemblies are merely provided to facilitate the understanding of the present disclosure. It should be appreciated that, a person skilled in the art may make further modifications and alternations without departing from the spirit of the present disclosure. In addition, for clarification, any known function and structure will not be described hereinafter.

It should be appreciated that, such phrases as “one embodiment” and “one of the embodiments” intend to indicate that the features, structures or characteristics are contained in at least one embodiment of the present disclosure, rather than referring to a same embodiment. In addition, the features, structures or characteristics may be combined in any embodiment or embodiments in an appropriate manner.

It should be further appreciated that, serial numbers of the steps shall not be used to define the order of the steps, and instead, the order of the steps shall be determined in accordance with their functions and internal logics.

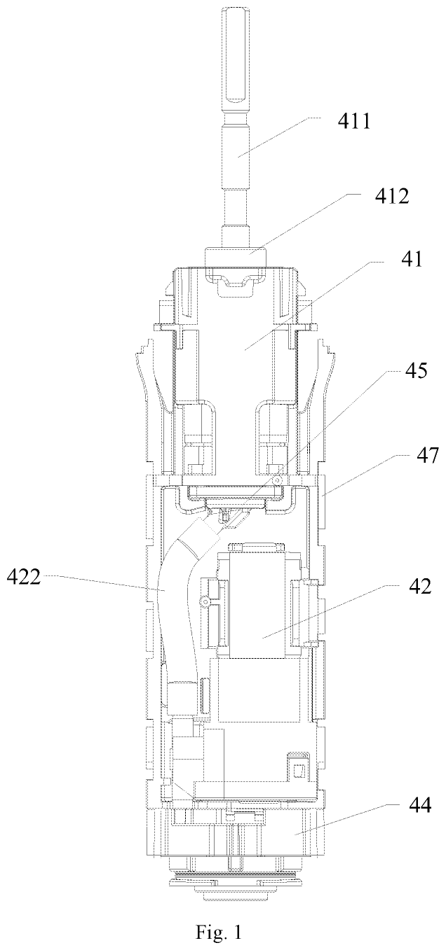

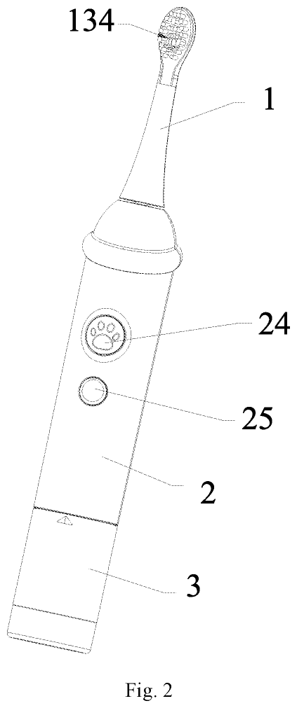

FIG. 1 shows a core assembly 4 according to one embodiment of the present disclosure, and the core assembly 4 is applied to an electric toothbrush. FIG. 2 shows the electric toothbrush which includes a toothbrush head 1, a toothbrush handle 2, a toothpaste chamber 3 and the core assembly 4.

As shown in FIG. 1, the core assembly 4 includes: a motor 41 including a hollow rotating shaft 411, a first end of the hollow rotating shaft 411 being coupled to the toothbrush head 1; a peristaltic pump 42, a first end of the peristaltic pump 42 being coupled to the toothpaste chamber 3, and a second end of the peristaltic pump 42 being coupled to a second end of the hollow rotating shaft 411; and a control assembly 43 electrically coupled to the peristaltic pump 42, and configured to control the peristaltic pump 42 to transfer toothpaste in the toothpaste chamber 3 through the hollow rotating shaft 411 to the toothbrush head 1, the control assembly 43 being further electrically coupled to the motor 41 and configured to control the motor 41 to operate so as to enable the toothbrush head 1 to vibrate for cleaning teeth.

In a possible embodiment of the present disclosure, the peristaltic pump 42 meets at least one of the following conditions: a motor speed of the peristaltic pump 42 is within a range of 12000 r/min to 18000 r/min, or a gear reduction ratio of the peristaltic pump 42 is within a range of 30:1 to 50:1.

In a possible embodiment of the present disclosure, the motor speed of the peristaltic pump 42 is within a range of 12000 r/min to 18000 r/min, and the gear reduction ratio of the peristaltic pump 42 is within a range of 30:1 to 50:1. It should be appreciated that, there is mutual exclusion between the motor speed and the gear reduction ratio. During the operation of the peristaltic pump 42, the larger the motor speed, the larger the flow rate of the toothpaste; and the larger the gear reduction rate, the larger the flow rate of the toothpaste. In the case that the motor speed and the gear reduction ratio meet the above-mentioned conditions, the flow rate of the toothpaste is adjusted through the peristaltic pump 42 conveniently.

For example, in the case that the motor speed of the peristaltic pump 42 is within a range of 12000 r/min to 18000 r/min, and the gear reduction ratio of the peristaltic pump 42 is within a range of 30:1 to 50:1, viscosity of the toothpaste is 6000 mpa·s to 20000 mpa·s, so as to ensure that 0.4 g to 0.7 g toothpaste is pushed within a time period of 2 s to 4 s.

Based on the above, through the above-mentioned method, the toothpaste is pushed in a rationed manner, so as to prevent a waste of the toothpaste, and prevent the mouth health from being adversely affected due to overuse of the toothpaste. For the toothpaste with different viscosity ranges, it may also be pushed in a rationed manner through adjusting the motor speed and the gear reduction rate of the peristaltic pump 42 according to the practical need. In the embodiments of the present disclosure, the viscosity of the toothpaste capable of being pushed by the peristaltic pump 42 is within a range of 6000 mpa·s to 20000 mpa·s, so it is able to provide a wider selection range and a wider application range of the toothpaste.

In the embodiments of the present disclosure, a flexible hose is squeezed and released alternately by the peristaltic pump 42 so as to pump a fluid, and it is unnecessary to provide an air intake-outtake structure to pressurize a gas, so it is able to simplify the structure of the entire electric toothbrush, reduce a size thereof, and prevent the occurrence of bubbles. Further, through the peristaltic pump 42, it is able to control the flow rate in a better manner, thereby to stably push the toothpaste in a rationed manner. In addition, the peristaltic pump 42 is not affected by an air pressure, so it is able to enlarge an application range of the electric toothbrush. Moreover, as compared with an air pump used in the related art, the peristaltic pump 42 has a smaller load current and lower power consumption when pushing the toothpaste, so it is able to prolong a service life of the electric toothbrush.

It should be appreciated that, bacteria breeding easily occurs at the toothbrush head 1 when it is used for a long time period. In order to ensure the mouth health, it is necessary to replace the toothbrush head 1 at a regular interval. In addition, after the toothpaste in the toothpaste chamber 3 has been used out, it is also necessary to replace the toothpaste chamber 3. Hence, in a possible embodiment of the present disclosure, the first end of the hollow rotating shaft 411 is detachably coupled to the toothbrush head 1, and the first end of the peristaltic pump 42 is detachably coupled to the toothpaste chamber 3, so as to facilitate the replacement of the toothbrush head 1 and the toothpaste chamber 3.

During the implementation, the control assembly 43 is a control circuit board. The control circuit board is configured to generate a corresponding signal in accordance with a user's operation, and control working states of the peristaltic pump 42 and the motor 41 in accordance with the signal, so as to deliver the toothpaste in the toothpaste chamber 3 to the toothbrush head 1 through the peristaltic pump 42 and enable the toothbrush head 1 to vibrate through the motor 41. In this way, a one-button tooth-brushing function is achieved through the peristaltic pump 42 and the motor 41.

The motor 41 is a sonic wave motor. In the embodiments of the present disclosure, as an essential component of the motor 41 (a power unit), the rotating shaft is designed as hollow, and a passage is formed in the rotating shaft for the delivery of the toothpaste. It should be appreciated that, in the related art, the rotating shaft of the motor is not hollow, and in this case, the second end of the peristaltic pump 42 needs to be coupled to the toothbrush head 1 through an additional transmission member. At this time, an additional space is occupied by the transmission member, so the size of the core assembly 4 is increased.

In the embodiments of the present disclosure, the core assembly 4 includes the motor 41, the peristaltic pump 42 and the control assembly 43, and the motor 41 includes the hollow rotating shaft 411. As an essential structure of the motor 41 (the power unit), the rotating shaft is designed as hollow, i.e., the passage for the delivery of the toothpaste is formed in the rotating shaft. When the hollow rotating shaft 411 of the motor 41 serves as the passage for the delivery of the toothpaste, it is able to reduce the quantity of components desired for the core assembly 4, and reduce a size of the core assembly 4 as well as a space occupied by the core assembly 4 in the electric toothbrush, thereby to reduce a size of the entire electric toothbrush and achieve a lightweight design of the electric toothbrush.

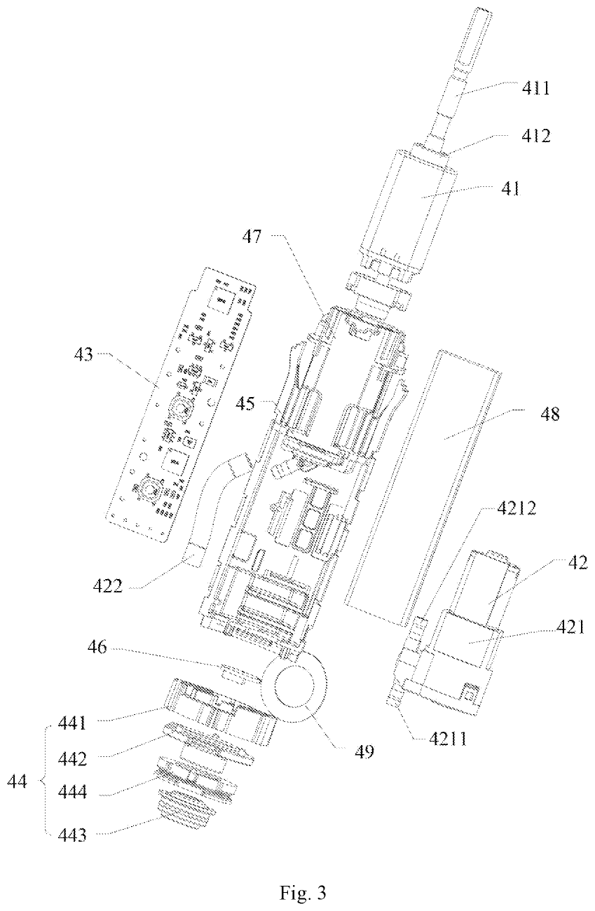

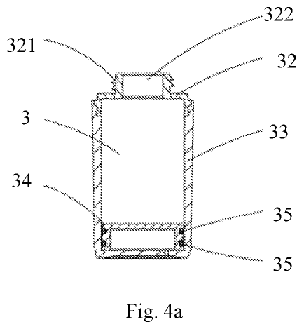

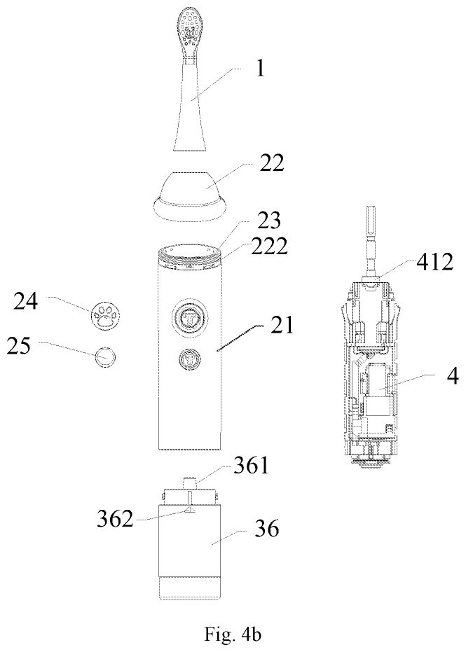

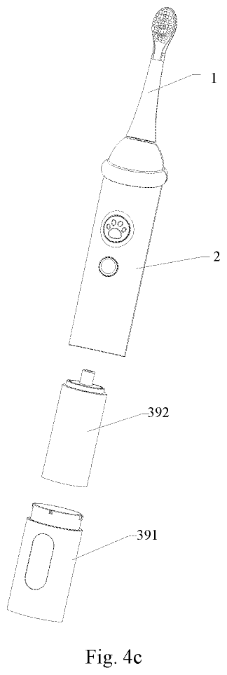

In a possible embodiment of the present disclosure, as shown in FIGS. 3 and 4b, the peristaltic pump 42 includes: a pump body 421 provided with a transmission passage, the transmission passage being provided with a first interface 4211 and a second interface 4212 opposite to each other in an extending direction of a central line of the toothbrush handle 2, the first interface 4211 being coupled to the toothpaste chamber 3; and a hose 422, a first end of the hose 422 being coupled to the second interface 4212, a second end of the hose 422 being coupled to the second end of the hollow rotating shaft 411.

The first interface 4211 and the second interface 4212 are arranged opposite to each other in the extending direction of the central line of the toothbrush handle 2. The toothbrush head 1 and the toothpaste chamber 3 are arranged at two ends of the toothbrush handle 2 respectively along the extending direction of the central line of the toothbrush handle 2. The first interface 4211 faces the toothpaste chamber 3, and the second interface 4212 faces the toothbrush head 1, so the first interface 4211 is coupled to the toothpaste chamber 3 conveniently, and the second interface 4212 is coupled to the hose 422 conveniently.

The second interface 4212 is coupled to the hollow rotating shaft 411 through the hose 422. The hose 422 is flexible, so it is able to achieve the flexible arrangement of the core assembly 4, and reduce the size of the core assembly 4.

It should be appreciated that, a specific material of the hose 422 will not be particularly defined herein. For example, the hose 422 is made of polyethylene (PE).

In the embodiments of the present disclosure, the fluid is pumped through the peristaltic pump 42, and it is unnecessary to provide an air intake-outtake structure to pressurize a gas, so it is able to simplify the structure of the entire electric toothbrush, reduce the size thereof, and prevent the occurrence of bubbles. In addition, through the peristaltic pump 42, it is able to control the flow rate in a better manner, thereby to stably push the toothpaste in a rationed manner. In addition, the peristaltic pump 42 is not affected by the air pressure, so it is able to enlarge the application range of the electric toothbrush.

In some embodiments of the present disclosure, the second end of the hollow rotating shaft 411 is directly coupled to the hose 422, and in some other embodiments of the present disclosure, the second end of the hollowing rotating shaft 411 is coupled to the hose 422 through a rigid tube.

In a possible embodiment of the present disclosure, the core assembly 4 further includes at least one of a first connection base 44 or a second connection base 45. The first end of the peristaltic pump 42 is coupled to the toothpaste chamber 3 through the first connection base 44, and the second end of the hollow rotating shaft 411 is coupled to the second end of the hose 422 through the second connection base 45.

Specific structures of the first connection base 44 and the second connection base 45 will not be particularly defined herein. The first connection base 44 is arranged between the peristaltic pump 42 and the toothpaste chamber 3, and the second connection base 45 is arranged between the hollow rotating shaft 411 of the motor 41 and the hose 422.

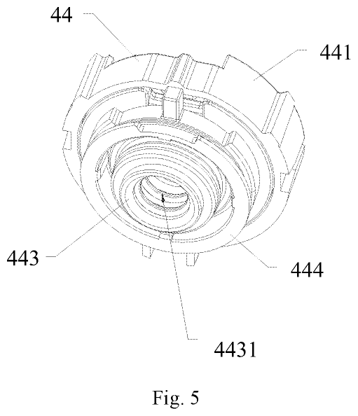

During the implementation, the first connection base 44 and the second connection base 45 are independent of each other or used in combination. For example, when the first connection base 44 has a structure in FIGS. 5 to 7, in the electric toothbrush, the hollow rotating shaft 411 of the motor 41 is coupled to the hose 422 directly, or through an additional tube, or through the second connection base 45 in FIG. 9, which will not be particularly defined herein.

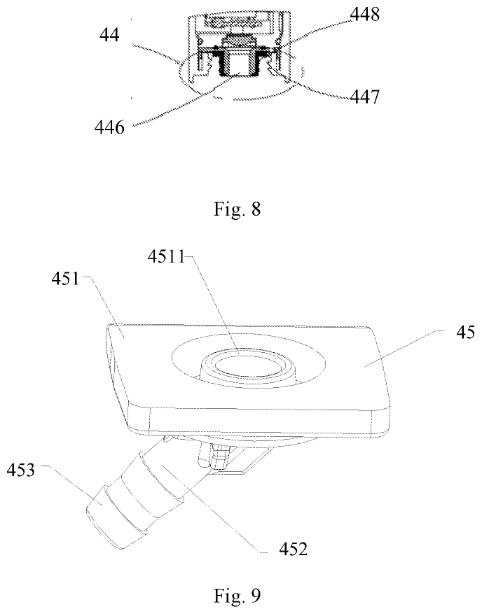

The structure of the first connection base 44 will be described hereinafter. The specific structure of the first connection base 44 will not be particularly defined herein. FIGS. 5 to 7 show an optional structure of the first connection base 44, and FIG. 8 shows another optional structure of the first connection base 44.

As shown in FIGS. 5 to 7, in a possible embodiment of the present disclosure, the first connection base 44 includes: a connection bracket 441 including a hole 4411 into which the first interface 4211 is inserted; a sealing cover 422 provided with a first via-hole, the first via-hole extending from a first side surface to a second side surface of the sealing cover 442, the first side surface being depressed to form a transition groove 4421 in communication with the first interface 4211, the second side surface extending outward to form an interface member 4422 in communication with the first via-hole; and a first sealing ring 443 sleeved onto the interface member 4422, the first sealing ring 443 being provided with a slot 4431 in communication with the toothpaste chamber 3.

The hole 4411 is formed in the connection bracket 441. During the implementation, the first interface 4211 of the peristaltic pump 42 is inserted into the hole 4411, so a size of the hole 4411 is adapted to a size of the first interface 4211, so as to improve the connection stability and sealing between the first interface 4211 and the hole 4411.

In a possible embodiment of the present disclosure, a diameter of the first interface 4211 of the peristaltic pump 42 is adapted to a diameter of the hole 4411 in the connection bracket 441, and the diameters of the first interface 4211 and the hole 4411 are each within a range of 2.0 mm to 2.5 mm. Further, in some embodiments of the present disclosure, the diameter of the first interface 4211 of the peristaltic pump 42 is the same as the diameter of the hole 4411 in the connection bracket 441.

A passage defined by the first interface 4211 and the hole 4411 in the connection bracket 441 is used to deliver the toothpaste. When a pore size of the passage is too small, an increased risk of damage occurs for the electric toothbrush due to congestion. When the pore size of the passage is too large, a waste of the toothpaste occurs due to residual toothpaste.

In the embodiments of the present disclosure, the diameter of the first interface 4211 and the diameter of the hole 4411 in the connection bracket 441 are set within an appropriate range, so as to prevent the passage from being blocked by particles in the toothpaste, thereby to prevent the electric toothbrush from being damaged. In addition, it is able to reduce the waste of toothpaste due to too much residual toothpaste in the passage with a too large pore size.

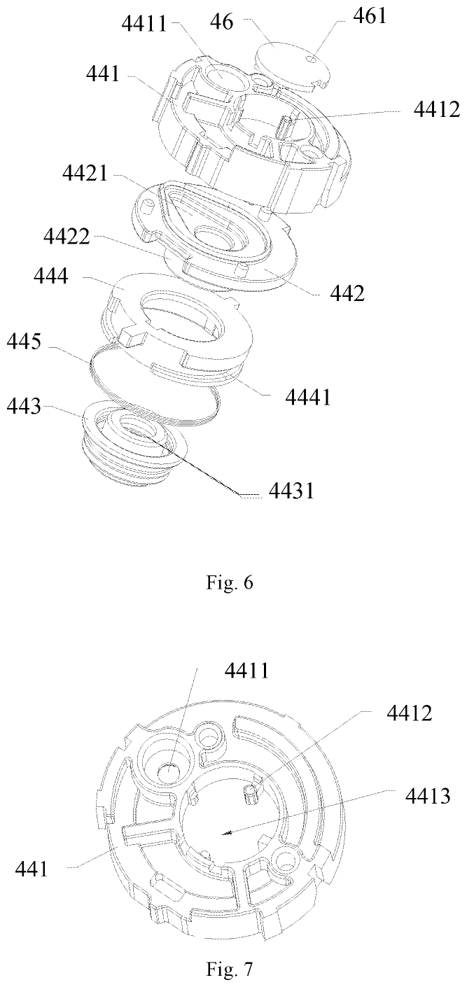

As shown in FIG. 6, the first side surface of the sealing cover 442 is depressed to form the transition groove 4421, and the transition groove 4421 is in communication with both the interface member 4422 and the hole 4411, so the transition groove 4421 serves as a transition region during the delivery of the toothpaste. The toothpaste in the toothpaste chamber 3 passes through the slot 4431 and the interface member 4422 into the transition groove 4421, and then passes through the hole 4411 and the first interface 4211 to the second interface 4212.

In a possible embodiment of the present disclosure, as shown in FIG. 6, the transition groove 4421 is of a drop-like shape, an end of the drop-like transition groove 4421 having a large size corresponds to the hole 4411. The first interface 4211 of the peristaltic pump 42 is inserted into the hole 4411 so as to be in communication with the transition groove 4421, so it is able to facilitate the installation of the peristaltic pump 42.

The second side surface of the sealing cover 442 extends outward to form the interface member 4422. The first sealing ring 443 is sleeved onto the interface member 4422 for hermeticity. The first sealing ring 443 is provided with the slot 4431 in communication with the toothpaste chamber 3, and the toothpaste chamber 3 is partially inserted into the slot 4431 so as to be coupled to the first connection base 44.

In the embodiments of the present disclosure, during the operation of the peristaltic pump 42, the toothpaste in the toothpaste chamber 3 enters the transition groove 4421 in the sealing cover 442, passes through the first interface 4421 into the peristaltic pump 42, passes through the second interface 4212 of the peristaltic pump 42 and the hose 422 into the second connection base 45, then passes through the second connection base 45 into the hollow rotating shaft 411 of the motor 41, and then passes through the hollow rotating shaft 411 of the motor 41 to the toothbrush head 1.

In the embodiments of the present disclosure, the toothpaste is delivered from the toothpaste chamber 3 through the first connection base 44, the peristaltic pump 42, the second connection base 45 and the hollow rotating shaft 411 to the toothbrush head 1. For the core assembly 4 in the embodiments of the present disclosure, a pipeline for the delivery of the toothpaste is divided into multiple sections, and an accommodation space of the electric toothbrush is saved through the hollow rotating shaft, so as to achieve the lightweight design of the electric toothbrush.

In the embodiments of the present disclosure, the toothpaste chamber 3 is coupled to the peristaltic pump 42 through the first connection base 44, so as to prevent a large space from being occupied when the toothpaste chamber 3 is coupled to the peristaltic pump 42 directly through the hose 422. On one hand, it is able for the toothpaste chamber 3 to be coupled to the peristaltic pump 42 conveniently. On the other hand, it is able to reduce a distance between, and a space desired for, the peristaltic pump 42 and the toothpaste chamber 3, thereby to provide a more compact structure and reduce the size of the entire electric toothbrush.

In a possible embodiment of the present disclosure, the toothpaste chamber 3 is provided with a chip 31 storing therein information about the toothpaste in the toothpaste chamber 3. In some embodiments of the present disclosure, the information about the toothpaste includes at least one of a toothpaste type, a toothpaste color, toothpaste viscosity and a toothpaste effect. In some other embodiments of the present disclosure, the information about the toothpaste further includes a toothpaste material, a manufacturer and a taste.

The first connection base 44 further includes: a coil bracket 444 arranged between the sealing cover 442 and the first sealing ring 443, and provided with a coil accommodation groove 4441; and a coil 445 arranged in the coil accommodation groove 4441 and configured to identify the chip 31.

During the implementation, the coil accommodation groove 4441 is formed in a side surface of the coil bracket 444, and the coil 445 is arranged in the coil accommodation groove 4441, so as to protect and limit the coil 445 to some extent, thereby to prevent the coil 445 from being damaged by an external force or offset.

Based on the structure of the first connection base 44, the coil bracket 444 is arranged between the sealing cover 442 and the first sealing ring 443, and the sealing cover 442 is arranged between the coil bracket 444 and the connection bracket 441. When the coil 445 is arranged in the coil accommodation groove 4441 in the coil bracket 444, it is able to facilitate the cooperation of the coil 445 with the chip 31. The coil 445 identifies the chip 31, and obtains the key information in the chip 31, i.e., the toothpaste type, the toothpaste color, the toothpaste viscosity and the toothpaste function, so as to control the push-out of the toothpaste and the selection of a tooth-brushing mode in a more accurate manner.

In a possible embodiment of the present disclosure, the core assembly 4 further includes a light plate 46 coupled to the connection bracket 441, electrically coupled to the control assembly 43, and configured to display different colors in accordance with a signal from the control assembly 43.

In the embodiments of the present disclosure, the first connection base 44 further includes the light plate 46 for displaying different colors, so as to achieve different lighting effects. A specific display mode will not be particularly defined herein.

In a possible embodiment of the present disclosure, a button is pressed by a user, so that the control assembly 43 transmits a signal to the light plate 46 and the light plate 46 displays different colors. For example, the light plate 46 displays three colors, i.e., red, green and blue, and the button is pressed so as to control the light plate 46 to be switched among these three colors. In some embodiments of the present disclosure, different colors indicate different tooth-brushing modes.

In another possible embodiment of the present disclosure, after the coil 445 identifies the chip 31 to obtain the toothpaste color, the light plate 46 displays a corresponding color under the control of the control assembly 43. For example, when the toothpaste is pink, the light plate 46 displays a pink color, and when the toothpaste is blue, the light plate 46 displays a blue color. In this way, it is able to provide the electric toothbrush with an excellent lighting effect. During the implementation, the toothpaste color is pink, blue, yellow, green, orange, purple, etc., which will not be particularly defined herein.

In some embodiments of the present disclosure, the toothpaste chamber 3 and the sealing cover 442 are made of a transparent material, and the coil bracket 444 is hollow, so as to facilitate light generated by the light plate 46 to reach the toothpaste chamber 3, thereby to provide an excellent lighting effect.

As shown in FIG. 7, during the implementation, a connection mode between the light plate 46 and the connection bracket 441 will not be particularly defined herein. For example, the light plate 46 is coupled to the connection bracket 441 through inserting a fixation column 4412 into a corresponding fixation hole 461. To be specific, the fixation column 4412 is formed on the connection bracket 441, and the fixation hole 461 is formed in the light plate 46.

As shown in FIG. 7, in some embodiments of the present disclosure, an installation space 4413 for receiving the light plate 46 is formed in the middle of the connection bracket 441, and the light plate 46 is fixed through inserting the fixation column 4412 on the connection bracket 441 into the fixation hole 461 in the light plate 6. In addition, the hole 4411 is formed in a side surface of the connection bracket 441, and the first interface 4211 of the peristaltic pump 42 is inserted into the hole 4411. Through the above-mentioned method, it is able to provide more components within a limited space, provide the electric toothbrush with a compact structure, reduce the size of the entire electric toothbrush, and facilitate the assembling of the light plate 46.

In a possible embodiment of the present disclosure, a light-emitting module is further arranged in the accommodation space, and it includes a light-emitting element and a lens arranged opposite to each other. The lens is arranged between the light-emitting element and the first connection base 44, and the light-emitting element is arranged close to the peristaltic pump 42 and emits light toward the lens.

In the embodiments of the present disclosure, the light-emitting element is a light-emitting diode, and the light from the light-emitting element passes through the lens toward the toothpaste chamber 3. For example, when the toothbrush handle 2 is picked up, the light is emitted by the light-emitting element of the light-emitting module and passes through the lens toward the toothpaste chamber 3, so as to illuminate the toothpaste chamber 3.

As shown in FIG. 8, in a possible embodiment of the present disclosure, the first connection base 44 includes: a first inlet 446 through which the toothpaste chamber 3 is in communication with the first end of the peristaltic pump 42; and a threaded unit 447 in threaded connection with the toothpaste chamber 3.

In a possible embodiment of the present disclosure, the first connection base 44 further includes an anti-leakage rubber member 448 enclosing the first inlet 446, i.e., the first connection base 44 includes the first inlet 446, the anti-leakage rubber member 448 and the threaded unit 447, so as to form, and seal, a liquid passage between the first end of the peristaltic pump 42 and the toothpaste chamber 3.

In a possible embodiment of the present disclosure, as shown in FIG. 9, the second connection base 45 includes: a seat 451 provided with a second via-hole, a side surface of the seat 451 facing the motor 41 being depressed to form an annular snap-in member 4511, the annular snap-in member 4511 being coupled to the motor 41 so that the second via-hole is in communication with the hollow rotating shaft 411; and a connector 452 arranged at a side of the seat 451 away from the motor 41 and coupled to the second end of the hose 422, an angle being formed between a central line of the connector 452 and a central line of the seat 451.

The hose 422 of the peristaltic pump 42 is coupled to the hollow rotating shaft 411 of the motor 41 through the second connection base 45, so two opposite side surfaces of the seat 451 are arranged in such a manner as to face the motor 41 and the hose 422 respectively. The side surface of the seat 451 facing the motor 41 is depressed to form the annular snap-in member 4511, and the annular snap-in member 4511 is adapted to the hollow rotating shaft 411, so as to facilitate the insertion of the hollow rotating shaft 411 into the annular snap-in member 4511, thereby to enable the seat 451 to be coupled to the hollow rotating shaft 411. The second via-hole formed in the seat 451 is in communication with the hollow rotating shaft 411, so as to form a toothpaste passage through which the toothpaste in the hose 422 of the peristaltic pump 42 is delivered to the hollow rotating shaft 411 of the motor 41.

By providing the annular snap-in member 4511, the hollow rotating shaft 411 is inserted into the annular snap-in member 4511, such that the second connection base 45 is coupled to the hollow rotating shaft 411 in a snap-in manner, thereby the sealing performance therebetween can be ensured, and the occurrence of toothpaste leakage during the delivery can be prevented. In addition, due to a limiting effect of the annular snap-in member 4511, it is able to facilitate the assembling of the second connection base 45 with the hollow rotating shaft 411.

It should be appreciated that, the connector 452 is arranged obliquely. In some embodiments of the present disclosure, the connector 452 extends obliquely to the seat 451, i.e., the connector 452 and the seat 451 form a one-piece structure. A value of the angle between the central lien of the connector 452 and the central line of the seat 451 will not be particularly defined herein. In a possible embodiment of the present disclosure, the angle is within a range of 40° to 60°, e.g., 45°.

When the second connection base 45 is coupled to the hose 422 through a straight-through joint, residual toothpaste easily occurs at the second connection base 45. In the embodiments of the present disclosure, the angle is formed between the connector 452 and the seat 451, so as to enable the toothpaste to flow more smoothly, thereby to prevent the residual toothpaste due to the straight-through joint. In addition, due to the existence of the angle, it is able to facilitate the insertion of the hose 422, thereby to improve the assembling efficiency of the core assembly 4.

In the embodiments of the present disclosure, the second connection base 45 is used as a transition member through which the peristaltic pump 42 is coupled to the hollow rotating shaft 411 of the motor 41, so as to increase a swing of the motor 41, reduce the difficulty in the assembling of the motor 41, provide the entire electric toothbrush with a more compact structure, and reduce the size thereof.

In the embodiments of the present disclosure, the core assembly 4 includes the first connection base 44 and the second connection base 45. The peristaltic pump 42 is coupled to the toothpaste chamber 3 through the first connection base 44, so as to provide the entire electric toothbrush with a compact structure and reduce the size thereof. The hose 422 of the peristaltic pump 42 is coupled to the hollow rotating shaft 411 of the motor 41 through the second connection base 45, so as to increase the swing of the motor 41, reduce the difficulty in the assembling of the motor 41, provide the entire electric toothbrush with a more compact structure, and reduce the size thereof.

In a possible embodiment of the present disclosure, multiple anti-drop layers 453 are arranged at an end of the connector 452 coupled to the hose 422, so as to prevent the hose 422 from falling off and ensure the sealing performance.

In a possible embodiment of the present disclosure, the electric toothbrush further includes a sealing gasket 412 sleeved onto the hollow rotating shaft 411 and in interference-fit connection with the hollow rotating shaft 411. An interference-fit width W between the sealing gasket 412 and the hollow rotating shaft 411 is within a range of 4 mm to 5 mm.

In the embodiments of the present disclosure, when the interference-fit width W between the sealing gasket 412 and the hollow rotating shaft 411 is within a range of 4 mm to 5 mm, it is able to provide an excellent waterproof effect, and prevent a swing of the toothbrush head 1 from being decreased due to an excessive interference-fit width. In addition, the sealing gasket 412 also has a sound absorption effect and a cushioning effect, so it is able to reduce a noise generated during the operation of the motor 41. In some embodiments of the present disclosure, the sealing gasket 412 is made of silica gel.

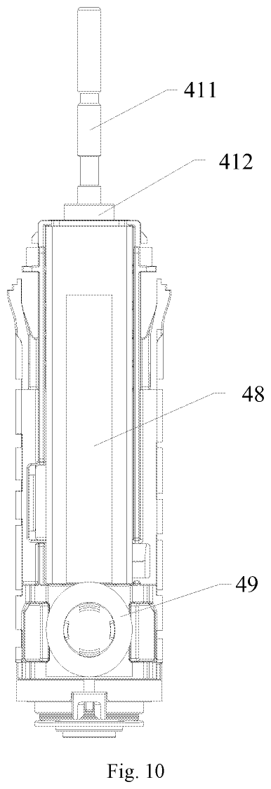

As shown in FIG. 10, in a possible embodiment of the present disclosure, the core assembly 4 further includes: a core bracket 47 on which the motor 41, the peristaltic pump 42 and the control assembly 43 are arranged; a battery 48 arranged on the core assembly 47 and configured to supply power to the motor 41 and the peristaltic pump 42; and a charge coil 49 arranged on the core bracket 47 and configured to charge the battery 48 in a wireless manner. In some embodiments of the present disclosure, the charge coil 49 is attached onto an inner surface of the toothbrush handle 2, so as to charge the battery in a wireless manner.

The present disclosure further provides in some embodiments an electric toothbrush, which includes a toothbrush head 1, a toothbrush handle 2, a toothpaste chamber 3 and the above-mentioned core assembly 4. The core assembly 4 is arranged inside the toothbrush handle 2.

In a possible embodiment of the present disclosure, the toothbrush handle 2 includes an accommodation space and a cavity, the cavity forms the toothpaste chamber 3, and the accommodation space is configured to receive the core assembly 4. A button assembly is further arranged on an outer surface of the toothbrush handle 2, and it includes a first button 25 configured to control the pushing of the toothpaste and a second button 24 configured to turn on and turn off the electric toothbrush and switch a tooth-brushing mode.

To be specific, the first button 25 is a physical button. When the first button 25 has received a first pressing operation, i.e., when the first button 25 is pressed, the control assembly 43 controls the peristaltic pump 42 to be started, so as to deliver the toothpaste in the toothpaste chamber 3 through the hollow rotating shaft 411 of the motor 41 to the toothbrush head 1. During the implementation, when the amount of the toothpaste at bristles 131 meets the requirement, the first button 25 is pressed to stop the peristaltic pump 42. Alternatively, a working duration of the peristaltic pump 42 is set in advance by the control assembly 43, and after the first button 25 is pressed, the peristaltic pump 42 operates for the predetermined working duration and then stops working automatically.

The second button 24 is also a physical button. When the second button 24 has received a second pressing operation, i.e., when the second button 24 is pressed, the electric toothbrush is turned on, or the tooth-brushing mode of the electric toothbrush is switched. The tooth-brushing modes of the electric toothbrush correspond to different tap positions of the motor 41, e.g., a high tap position, an intermediate tap position, and a low tap position.

In the embodiments of the present disclosure, when the second button 24 is pressed, the motor 41 is started to vibrate, so as to drive the toothbrush head 1 to vibrate for the tooth brushing. In addition, when the toothbrush head 1 vibrates, it is able to help the toothpaste extruded by the peristaltic pump 42 onto the toothbrush head 1 to bubble. Through the cooperation of the peristaltic pump 42 with the motor 41, it is able for the electric toothbrush to achieve a one-button automatic liquid discharging function and an electric tooth-brushing function. In some other embodiments of the present disclosure, after the toothpaste has been extruded by the peristaltic pump 42, the motor 41 is started automatically, i.e., the second button 24 is used to switch the tap positions of the motor 41. When the tooth brushing needs to be stopped, the second button is pressed so as to stop the motor 41.

It should be appreciated that, the first pressing operation and the second pressing operation may each be a short-press operation or a long-press operation. In a possible embodiment of the present disclosure, the first button 25 is short-pressed or long-pressed to start or close the peristaltic pump 42, the second button 24 is short-pressed to switch the tooth-brushing mode, and the second button 24 is long-pressed to turn on or off the electric toothbrush, which will not be particularly defined herein.

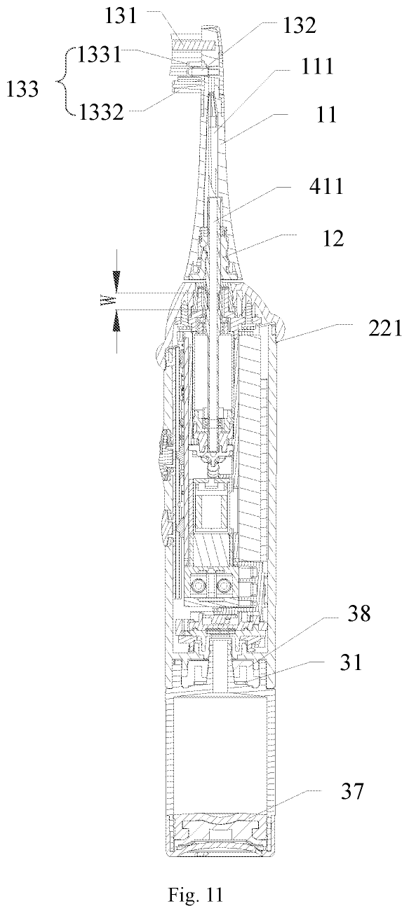

In some embodiments of the present disclosure, any other buttons may also be provided on the outer surface of the toothbrush handle 2, and the quantity of buttons and the functions thereof will not be particularly defined herein. As shown in FIG. 11, in a possible embodiment of the present disclosure, the toothbrush head 1 includes: a toothbrush rod 11 having a hollow channel 111 in communication with the hollow rotating shaft 411; a rotating shaft bracket 12 arranged inside the toothbrush rod 11 and assembled with the hollow rotating shaft 411 to limit the hollow rotating shaft 411; and a head 13 provided with bristles, a one-way valve 132 and a flexible rubber column 133, a liquid outlet space 134 being formed between the flexible rubber column 133 and each bristle 131, and the one-way valve 132 being arranged between the liquid outlet spaces 134 and in communication with the hollow channel 111.

In some embodiments of the present disclosure, the one-way valve 132 is flexible rubber one-way valve with an opening. When it is unnecessary for the electric toothbrush to push the toothpaste to the bristles, an external foreigner is prevented from being in contact with the toothpaste in the hollow channel 111 through the one-way valve, so as to prevent the toothpaste from being polluted, and slow down a water loss and an increase in the viscosity of the toothpaste. When it is necessary for the electric toothbrush to push the toothpaste to the bristles, the toothpaste flows through the one-way valve, so as to prevent the hollow channel 111 from being blocked due to the residual toothpaste at the liquid outlet of the toothbrush head 1.

In the embodiments of the present disclosure, the toothbrush rod 11 is provided with the hollow channel 111, so it is able to reduce a weight of the toothbrush head 1, and improve the reliability and shatter-resistance of the hollow channel 111.

In a possible embodiment of the present disclosure, the rotating shaft bracket 12 is further arranged in the hollow channel 111. The head 13 is arranged at an end of the toothbrush rod 11 away from the toothbrush handle 2, and the bristles 131, the one-wave valve 132 and the flexible rubber columns are arranged at different positions of the head 13.

The toothbrush rod 11 is provided with the hollow channel 111. The hollow channel 111 is in communication with the hollow rotating shaft 411, so that the toothpaste passes through the hollow rotating shaft 411 into the hollow channel 111, then passes through the one-way valve 132 into the liquid outlet space 134, and finally reaches the bristle 131.

It should be appreciated that, under the effect of the one-way valve 132, the toothpaste merely flows from the hollow channel 111 to the liquid outlet space 134. In this way, it is able to prevent the hollow channel 111 from being blocked due to the residual toothpaste at the liquid outlet of the toothbrush head, thereby to ensure the smooth delivery of the toothpaste.

In a possible embodiment of the present disclosure, the opening of the one-way valve 132 is arranged longitudinally. The flexible rubber columns 133 include an upper flexible rubber column 1331 and a lower flexible rubber column 1332. The lower flexible rubber column 1332 is arranged closer to the toothbrush handle 2 than the upper flexible rubber column 1331, and a length of the upper flexible rubber column 1331 is smaller than a length of the lower flexible rubber column 1332.

It should be appreciated that, the opening of the one-way valve 132 extends in a longitudinal direction in the case that the electric toothbrush is set upright, so the toothpaste flows into the liquid outlet space from top to down. In this way, it is able to prolong a flow path of the toothpaste, thereby to prevent the overflow of the toothpaste when the toothpaste is extruded in a transverse direction.

In the embodiment of the present disclosure, when the length of the upper flexible rubber column 1331 is smaller than the length of the lower flexible rubber column 1332, it is able to enlarge the liquid outlet space 134, and prevent the toothpaste from dropping off the toothbrush head when the liquid outlet space is filled up with the toothpaste. In some embodiments of the present disclosure, the length of the upper flexible rubber column 1331 is a half of the length of the lower flexible rubber column 1332.

It should be appreciated that, a specific structure of the toothpaste chamber 3 will not be particularly defined herein. FIGS. 4a, 4b and 4c show a plurality of optional toothpaste chambers 3.

As shown in FIG. 4a, in a possible embodiment of the present disclosure, the toothpaste chamber 3 includes a cover 32, a first vial body 33, a first piston 34 and a third sealing ring 35. The cover 32 is in hermetic connection with the first vial body 33, the first piston 34 abuts against the first vial body 33 at an end away from the cover 32, and the third sealing ring 35 is arranged between the first piston 34 and the first vial body 33.

In the embodiments of the present disclosure, the cover 32 is an upper cover coupled to the peristaltic pump 42. The first vial body 33 is sealed with the cover 32 in a close-fitting or supersonic connection manner. In a possible embodiment of the present disclosure, the first vial body 33 is transparent.

When the electric toothbrush needs to be used, air in the first vial body 33 is suctioned by the peristaltic pump 42, so that the piston moves toward the cover 32 so as to push the toothpaste in the first vial body 33 toward the peristaltic pump 42. The toothpaste in the first vial body 33 is continuously extruded to the toothbrush head 1, and finally reaches a side of the bristle 131 on the toothbrush head 1 in contact with teeth.

In a possible embodiment of the present disclosure, the cover 32 is in threaded connection with the threaded unit 447 of the first connection base 44 through a thread structure, and the cover 32 is further provides a liquid outlet 322. The cover 32 is in communication with the first inlet 446 in the first connection base 44 through the liquid outlet 322, and then in communication with the peristaltic pump 42 through the first connection base 44. In other words, the toothpaste chamber 3 in FIG. 4a is assembled with the first connection base 44 in FIG. 8 through threaded connection.

In the embodiments of the present disclosure, the cover 32 is coupled to the first vial body 33 through the thread structure 321, so as to prevent the toothpaste in the first vial body 33 from being oxidized. The toothpaste in the first vial body flows through the liquid outlet 332 in the cover 32.

In a possible embodiment of the present disclosure, the toothpaste chamber 3 has a same diameter as the toothbrush handle 2, and the toothpaste chamber is detachably coupled to the toothbrush handle 2 through threaded connection, so as to facilitate the assembling.

As shown in FIG. 4b, in a possible embodiment of the present disclosure, the toothpaste chamber 3 includes: a second vial body 36 including a vial opening 361; a chip 31 arranged in the vial opening 361 and configured to store information about the toothpaste in the toothpaste chamber; and a second piston 37 arranged in the second vial body 36 and configured to push the toothpaste in the second vial body 36 during the operation of the peristaltic pump 42.

In some embodiments of the present disclosure, the toothpaste chamber 3 further includes a chip protection cover 38 for protecting the chip 31 from being damaged or falling off. In some other embodiments of the present disclosure, the second vial body 36 is provided with an indication mark 362, so as to facilitate the assembling of the toothpaste chamber 3 with the toothbrush handle 2.

In the embodiments of the present disclosure, the chip 31 is arranged in the vial opening 361, so as to facilitate the identification of the chip 31. In a possible embodiment of the present disclosure, the vial opening 361 of eh second vial body is inserted into the interface member 4422 of the first connection base 44, so as to enable the toothpaste chamber 3 to be coupled to the first connection base 44, thereby to enable the toothpaste chamber 3 to be coupled to the toothbrush handle 2.

In a possible embodiment of the present disclosure, the second vial body 36 is coupled to the toothbrush handle 2 through spinning, threaded connection, or magnetic adsorption.

In some embodiments of the present disclosure, the second vial body 36 and the toothbrush handle 2 are provided with a fastener and a slot respectively, and the fastener is inserted into the slot and then rotated so as to enable the second vial body 36 to be coupled to the toothbrush handle 2 through spinning. In this way, it is able to improve the assembling convenience and the connection reliability between the toothpaste chamber 3 and the toothbrush handle 2, and simplify the molding.

In some embodiments of the present disclosure, an outer wall of the second vial body 35 is provided with a thread structure engaged with a thread structure on an inner wall of the toothbrush handle 2, so that the second vial body 36 is coupled to the toothbrush handle 2 through threaded connection. To be specific, at least a part of the second vial body 36 is spun into the toothbrush handle 2.

In some other embodiments of the present disclosure, magnetic members are arranged on the second vial body 36 and the toothbrush handle 2, so that the second via-hole 36 is coupled to the toothbrush handle 2 through magnetic adsorption.

In a possible embodiment of the present disclosure, as shown in FIG. 4c, the toothpaste chamber 3 includes a body 391 and a vial 392. The body 391 is coupled to the toothbrush handle 2 through clamping, threaded connection, or magnetic adsorption. The vial 392 is arranged in the body 391, and coupled to the first connection base 44 in the toothbrush handle 2.

As shown in FIGS. 4b and 4c, the toothpaste chamber 3 in FIG. 4c differs from that in FIG. 4b in that, the toothpaste chamber 3 in FIG. 4c includes two parts, i.e., the body 391 and the vial 392, the body 391 is coupled to the toothbrush handle 2 through clamping, threaded connection or magnetic adsorption (clamping in FIG. 4c), and the vial 392 is arranged in the body 391 and coupled to the first connection base 44 in the toothbrush handle 2. For the toothpaste chamber 3 in FIG. 4c, when the toothpaste needs to be replaced, it is merely necessary to replace the vial 392 in the body 391, so it is able to facilitate the replacement, and ensure the cleanness of the toothpaste.

In a possible embodiment of the present disclosure, as shown in FIG. 4b, the toothbrush handle 2 includes: a housing 21 on which a fastener 221 is arranged; a top cover 22 provided with a slot 222 adapted to the fastener 221, the top cover 22 being coupled to the housing 21 through the slot 222 and the fastener 221; and a waterproof sealing ring 23 sleeved onto a joint between the housing 21 and the top cover 22.

In the embodiments of the present disclosure, the housing 21 is assembled with the core bracket 47 through clamping, and the waterproof sealing ring 23 is arranged at the joint between the housing 21 and the top cover 22. The waterproof sealing ring 23 is elastic, so it may push up the top cover 22 so that a gap is formed between the top cover 22 and the housing 21. When the top cover 22 is coupled to the housing 21 through the fastener 221 and the slot 222, it is able to prevent the waterproof sealing ring 23 from pushing up the top cover 22, thereby to prevent the occurrence of the gap between the top cover 22 and the housing 21, and improve the sealing of the toothbrush handle 2.

Based on the above, the electric toothbrush in the embodiments of the present disclosure at least has the following beneficial effects.
1. The toothpaste is pushed through the peristaltic pump 42 without any air intake and outtake structures, so it is able to simplify the structure of the entire electric toothbrush, reduce the size thereof, and prevent the occurrence of bubbles. In addition, through the peristaltic pump 42, it is able to control the flow rate of the toothpaste in a better manner, thereby to stably push the toothpaste in a rationed manner. Moreover, the peristaltic pump 42 is not affected by the air pressure, so it is able to enlarge an application range of the electric toothbrush.
2. The toothpaste chamber 3 is coupled to the peristaltic pump 42 through the first connection base 44, so it is able to reduce an occupied space when the toothpaste chamber 3 is directly coupled to the peristaltic pump 42 through a connection tube. Through the design of the first connection base 44, it is able to facilitate the coupling of the toothpaste chamber 3 with the peristaltic pump 42, and meanwhile reduce a distance and a space between the peristaltic pump 42 and the toothpaste chamber 3, thereby to provide a more compact structure and reduce the size of the entire electric toothbrush.
3. The pore size of the first interface 4211 of the peristaltic pump 42 and the diameter of the hole 4411 in the first connection base 44 are within a range of 2.0 mm to 2.5 mm, so it is able to prevent the electric toothbrush from being damaged when the passage for the toothpaste is blocked by the particles in the toothpaste, and prevent the occurrence of residual toothpaste and a waste of the toothpaste when the passage is too large.
4. The peristaltic pump 42 is provided with the specific motor speed and the specific gear reduction ratio, so it is able to adjust the flow rate of the toothpaste, and ensure that 0.4 g to 0.7 g toothpaste is pushed within a time period of 2 s to 4 s. In addition, it is able to push the toothpaste having viscosity of 6000 mpa·s to 20000 mpa·s, thereby to enlarge the selection range and application range of the toothpaste, and meet different requirements.
5. The peristaltic pump 42 is coupled to the hollow rotating shaft 411 of the motor 41 through the second connection base 45 as a transition member, so it is able to increase the swing of the motor, and reduce the difficulty in the assembling of the motor. In addition, it is able to provide a more compact structure, and reduce the size of the entire electric toothbrush.
6. The angle is formed between the connector 452 of the second connection base 45 and the seat 451, so it is able for the toothpaste to flow more smoothly, thereby to prevent the residual toothpaste due to the straight-through joint. In addition, due to the existence of the angle, it is able to facilitate the insertion of the hose 422 during the assembling, thereby to improve the assembling efficiency.
7. The sealing gasket 412 is in interference-fit connection with the hollow rotating shaft 411, and the interference-fit width is within a range of 4 mm to 5 mm, so as to provide an excellent waterproof effect, and prevent the swing of the toothbrush head 1 from being decreased due to an excessive interference-fit width.
8. Through the connection structure (the first connection base 44 and the second connection base 45), it is able to improve the assembling of the electric toothbrush as well as the reliability and consistency of the electric toothbrush. The peristaltic pump 42 is coupled to the first connection base 44 through the sealing flexible rubber ring, and coupled to the second connection base 45 through a PE tube, i.e., the connection at two ends of the peristaltic pump 42 is soft contact, so it is able to reduce the noise generated due to the resonance of the peristaltic pump 42.
9. During the pushing of the toothpaste, as compared with the air pump, the peristaltic pump 42 has a smaller load current and lower power consumption, so it is able to prolong a service life of the electric toothbrush.

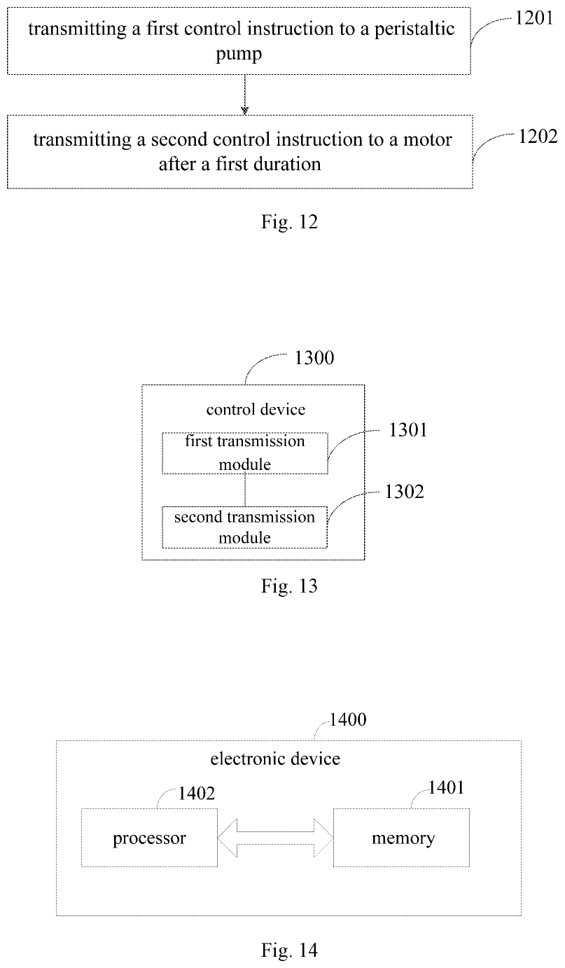

As shown in FIG. 12, the present disclosure further provides in some embodiments a control method, which includes: Step 1201 of transmitting a first control instruction to the peristaltic pump 42, the first control instruction being used to indicate the peristaltic pump 42 to be in a working state for a first duration so as to push toothpaste in the toothpaste chamber 3 to the toothbrush head 1; and Step 1202 of transmitting a second control instruction to the motor 41 after the first duration, the second control instruction being used to indicate the motor 41 to be in a working state for a second duration.

The control method in the embodiments of the present disclosure may be executed by the control assembly 43 of the electric toothbrush, or a processor, which will not be particularly defined herein. For ease of description, the following description will be given when the control method is executed by the control assembly 43.

In a possible embodiment of the present disclosure, an instruction is inputted by a user through pressing a button, so that the control assembly 43 transmits the first control instruction to the peristaltic pump 42, and the peristaltic pump 42 operates for the first duration in accordance with the first control instruction and pushes the toothpaste to the toothbrush head 1.

After the peristaltic pump 42 has pushed the toothpaste to the toothbrush head 1, in one case, an instruction is inputted by the user through pressing a button, so that the control assembly 43 transmits the second control instruction to the motor 41, and the motor 41 operates for the second duration in accordance with the second control instruction. In another case, after the first duration, the control assembly 43 automatically transmits the second control instruction to the motor 41.

It should be appreciated that, during the implementation, an instruction is further inputted by the user through pressing a button, so as to stop the peristaltic pump 42 or the motor 41 at any time.

In some embodiments of the present disclosure, the first control instruction carries operation data about the peristaltic pump 42, and the operation data includes a motor speed and a gear reduction ratio of the peristaltic pump 42. In some other embodiments of the present disclosure, the operation data about the peristaltic pump 42 is preset. In some other embodiments of the present disclosure, the control assembly 43 obtains the operation data about the peristaltic pump 42 through identifying the chip 31.

In some embodiments of the present disclosure, the second control instruction carries operation data about the motor 41, and the operation data includes a vibration frequency of the motor 41. In some other embodiments of the present disclosure, the operation data about the motor 41 is preset. In some other embodiments of the present disclosure, the control assembly 43 obtains the operation data about the motor 41 through identifying the chip 31.

Of course, during the implementation, an instruction is also inputted by the user through pressing a button, so as to adjust the operation data about the peristaltic pump 42 and the operation data about the motor 41 in real time.

It should be appreciated that, during the implementation, the instruction is inputted by the user in various ways. For example, in some embodiments of the present disclosure, different instructions are inputted through pressing different buttons. In some other embodiments of the present disclosure, different instructions are inputted through long-pressing or short-pressing a button, or pressing the button continuously.

Of course, in some embodiments of the present disclosure, the instruction is inputted by the user in any other ways. For example, control information is transmitted to the control assembly 43 through an application (APP), so as to indicate the control assembly 43 to transmit different control instructions.

In a possible embodiment of the present disclosure, during the operation of the peristaltic pump 42, a pushing state or a real-time position of the toothpaste is indicated through a corresponding indicator. Identically, during the operation of the motor 41, the working state of the motor is also indicated through a corresponding indicator.

In a possible embodiment of the present disclosure, the control method further includes transmitting a third control instruction to the light plate 46, and the third control instruction is used to indicate the light plate 46 to emit light in accordance with a predetermined strategy.

In a possible embodiment of the present disclosure, an instruction is inputted by the user through pressing a button, so that the control assembly 43 transmits the third control instruction to the light plate 46, and the light plate 46 emit light in accordance with the predetermined strategy in the third control instruction. The predetermined strategy includes at least one of a color of the light, a duration, or a lighting mode (e.g., always-on, flickering, or flashing in different colors).

In another possible embodiment of the present disclosure, the control assembly 43 transmits the third control instruction to the light plate 46 in accordance with a color of the toothpaste in the toothpaste chamber 3, so as to control the light plate 46 to emit light in a corresponding color and determine the duration and the lighting mode in accordance with the predetermined strategy.

The following description will be given hereinafter illustratively when the electric toothbrush is controlled by the above-mentioned control method. In the following, the control assembly 43 is a control circuit board.

The toothpaste or toothpaste vial is placed into the toothpaste chamber 3. The coil 445 in the toothbrush handle 2 identifies the chip 31 on the toothpaste chamber 3, so as to obtain the toothpaste type, the toothpaste color, the toothpaste viscosity and a control logic in the chip 31. The control logic includes, but not limited to, a light color, a lighting mode (flickering or always-on), a duration, the quantity of push-outs of the toothpaste, a working duration of the peristaltic pump 42, a working duration of the motor 41, and a vibration frequency of the motor 41.

A button is pressed by the user (long-pressed or short-pressed), so as to trigger the control circuit board to transmit the first control instruction to the peristaltic pump 42. The peristaltic pump 42 operates for the corresponding duration in accordance with the first control instruction, so as to push the toothpaste to the toothbrush head.

After the peristaltic pump 42 operates for the corresponding duration, the control circuit board automatically transmits the second control instruction to the motor 41, so as to control the motor 41 to operate for the corresponding duration. Alternatively, a button is pressed by the user, so as to trigger the control circuit board to transmit the second control instruction to the motor 41, thereby to enable the motor 41 to operate for the corresponding duration in accordance with the second control instruction.

Further, a button is long-pressed by the user, so as to trigger the control circuit board to transmit a stop signal to the motor 41, so as to stop the motor 41.

In the embodiments of the present disclosure, the type and efficacy of the toothpaste are identified in accordance with the chip 31, and the peristaltic pump 42 and the motor 41 are controlled in accordance with the control logic in the chip 31, so as to set the vibration frequency and duration of the motor 41 for each type of toothpaste, thereby to provide an optimum tooth-brushing mode and ensure an excellent cleaning effect.

As shown in FIG. 13, the present disclosure further provides in some embodiments a control device 1300, which includes: a first transmission module 1301 configured to transmit a first control instruction to a peristaltic pump, the first control instruction being used to indicate the peristaltic pump to be in a working state for a first duration so as to push toothpaste in a toothpaste chamber to a toothbrush head; and a second transmission module 1302 configured to transmit a second control instruction to a motor after the first duration, the second control instruction being used to indicate the motor to be in a working state for a second duration.

In a possible embodiment of the present disclosure, the control device 1300 further includes a third transmission module configured to transmit a third control instruction to a light plate, and the third control instruction is used to indicate the light plate to emit light in accordance with a predetermined strategy.

The control device 1300 in the embodiments of the present disclosure is used to implement the above-mentioned method in FIG. 12, which will not be particularly defined herein.

As shown in FIG. 14, the present disclosure further provides in some embodiments an electronic device 1400, which includes a processor 1401, a memory 1402, and a program or instruction stored in the memory 1402 and executed by the processor 1401. The program or instruction is executed by the processor 1401 so as to implement the above-mentioned method in FIG. 12 with a same technical effect, which will not be particularly defined herein.

The present disclosure further provides in some embodiments a readable storage medium storing therein a program. The program is executed by a processor, so as to implement the above-mentioned method in FIG. 12 with a same technical effect, which will not be particularly defined herein. The readable storage medium may be a Read-Only Memory (ROM), a Random Access Memory (RAM), a magnetic disk or an optical disk.

It should be further appreciated that, the device and method may be implemented in any other ways. For example, the embodiments for the apparatus is merely for illustrative purposes, and the modules or units are provided merely on the basis of their logic functions. During the actual application, some modules or units may be combined together or integrated into another system. Alternatively, some functions of the module or units may be omitted or not executed. In addition, the coupling connection, direct coupling connection or communication connection between the modules or units may be implemented via interfaces, and the indirect coupling connection or communication connection between the modules or units may be implemented in an electrical or mechanical form or in any other form.

In addition, the functional units in the embodiments of the present disclosure may be integrated into a processing unit, or the functional units may exist independently, or two or more functional units may be combined together. These units may be implemented in the form of hardware, or hardware plus software.

The functional units implemented in a software form may be stored in a computer-readable medium. These software functional units may be stored in a storage medium and include several instructions so as to enable a computer device (a personal computer, a server or network device) to execute all or parts of the steps of the method according to the embodiments of the present disclosure. The storage medium includes any medium capable of storing therein program codes, e.g., a universal serial bus (USB) flash disk, a mobile hard disk (HD), an ROM, an RAM, a magnetic disk or an optical disk.

In the embodiments of the present disclosure, such words as “in the middle of”, “longitudinal”, “lateral”, “length”, “width”, “thickness”, “on/above”, “under/below”, “front”, “back”, “left”, “right”, “vertical”, “horizontal”, “top”, “bottom”, “inside”, “outside”, “clockwise” and “counter-clockwise” may be used to indicate directions or positions as viewed in the drawings, and they are merely used to facilitate the description in the present disclosure, rather than to indicate or imply that a device or member must be arranged or operated at a specific position.

In addition, such words as “first” and “second” are merely used to differentiate different components rather than to represent any order, number or importance, i.e., they are used to implicitly or explicitly indicate that there is at least one component. Further, such a phrase as “a plurality of” is used to indicate that there are at least two, e.g., two or three, components, unless otherwise specified.

Unless otherwise specified, such words as “arrange”, “connect”, “couple” and “fix” may have a general meaning, e.g., the word “connect” may refer to fixed connection, removable connection or integral connection, or mechanical or electrical connection, or direct connection or indirect connection via an intermediate component, or communication between two components, or wired or wireless communication connection. The meanings of these words may be understood by a person skilled in the art in accordance with the practical need.

Unless otherwise defined, when a first feature is arranged on or under a second feature, the first feature is in direct contact with the second feature, or in contact with the second feature through any other feature. In addition, when the first feature is on/above the second feature, the first feature is arranged on/above, or right on/above, the second feature, or the first feature is arranged at a level higher than the second feature. When the first feature is under/below the second feature, the first feature is arranged under/below, or right under/below, the second feature, or the first feature is arranged at a level lower than the second feature.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A core assembly applied to an electric toothbrush, the electric toothbrush comprising a toothbrush head, a toothbrush handle and a toothpaste chamber, the core assembly comprising:
a motor comprising a hollow rotating shaft, a first end of the hollow rotating shaft being coupled to the toothbrush head;
a peristaltic pump, a first end of the peristaltic pump being coupled to the toothpaste chamber, and a second end of the peristaltic pump being coupled to a second end of the hollow rotating shaft; and
a control assembly electrically coupled to the peristaltic pump, and configured to control the peristaltic pump to transfer toothpaste in the toothpaste chamber through the hollow rotating shaft to the toothbrush head, the control assembly being further electrically coupled to the motor and configured to control the motor to operate so as to enable the toothbrush head to vibrate.

2. The core assembly according to claim 1, wherein the peristaltic pump comprises:
a pump body provided with a transmission passage, the transmission passage being provided with a first interface and a second interface opposite to each other in an extending direction of a central line of the toothbrush handle, the first interface being coupled to the toothpaste chamber; and
a hose, a first end of the hose being coupled to the second interface, a second end of the hose being coupled to the second end of the hollow rotating shaft.

3. The core assembly according to claim 2, further comprising at least one of a first connection base or a second connection base, wherein the first end of the peristaltic pump is coupled to the toothpaste chamber through the first connection base, and the second end of the hollow rotating shaft is coupled to the second end of the hose through the second connection base.

4. The core assembly according to claim 3, wherein the first connection base comprises:
a connection bracket comprising a hole into which the first interface is inserted;
a sealing cover provided with a first via-hole, the first via-hole extending from a first side surface to a second side surface of the sealing cover, the first side surface being depressed to form a transition groove in communication with the first interface, the second side surface extending outward to form an interface member in communication with the first via-hole; and
a first sealing ring sleeved onto the interface member, the first sealing ring being provided with a slot in communication with the toothpaste chamber.

5. The core assembly according to claim 4, wherein a diameter of the first interface of the peristaltic pump is adapted to a diameter of the hole in the connection bracket, and the diameters of the first interface and the hole are each within a range of 2.0 mm to 2.5 mm.

6. The core assembly according to claim 4, wherein the toothpaste chamber is provided with a chip storing therein information about the toothpaste in the toothpaste chamber,
wherein the first connection base further comprises:
a coil bracket arranged between the sealing cover and the first sealing ring, and provided with a coil accommodation groove; and
a coil arranged in the coil accommodation groove and configured to identify the chip.

7. The core assembly according to claim 6, wherein the first connection base further comprises a light plate coupled to the connection bracket, electrically coupled to the control assembly, and configured to display different colors in accordance with a signal from the control assembly.

8. The core assembly according to claim 3, wherein the first connection base comprises:
a first inlet through which the toothpaste chamber is in communication with the first end of the peristaltic pump;
a threaded unit in threaded-connection with the toothpaste chamber; and
an anti-leakage rubber member enclosing the first inlet.

9. The core assembly according to claim 3, wherein the second connection base comprises:
a seat provided with a second via-hole, a side surface of the seat facing the motor being depressed to form an annular snap-in member, the annular snap-in member being coupled to the motor so that the second via-hole is in communication with the hollow rotating shaft; and
a connector arranged at a side of the seat away from the motor and coupled to the second end of the hose, an angle being formed between a central line of the connector and a central line of the seat.

10. The core assembly according to claim 9, wherein the angle is within a range of 40° to 60°.

11. The core assembly according to claim 1, wherein the electric toothbrush further comprises a sealing gasket sleeved onto the hollow rotating shaft and in interference-fit connection with the hollow rotating shaft, and an interference-fit width between the sealing gasket and the hollow rotating shaft is within a range of 4 mm to 5 mm.

12. The core assembly according to claim 1, wherein the peristaltic pump meets at least one of the following conditions: a motor speed of the peristaltic pump is within a range of 12000 r/min to 18000 r/min, or a gear reduction ratio of the peristaltic pump is within a range of 30:1 to 50:1.

13. The core assembly according to claim 1, further comprising:
a core bracket on which the motor, the peristaltic pump and the control assembly are arranged;
a battery arranged on the core assembly and configured to supply power to the motor and the peristaltic pump; and
a charge coil arranged on the core bracket and configured to charge the battery in a wireless manner.

14. An electric toothbrush, comprising a toothbrush head, a toothbrush handle, a toothpaste chamber, and the core assembly according to claim 1, wherein the core assembly is arranged in the toothbrush handle; wherein the toothbrush handle comprises an accommodation space and a cavity, the cavity forms the toothpaste chamber, and the accommodation space is configured to receive the core assembly, wherein a button assembly is further arranged on an outer surface of the toothbrush handle, and comprises a first button configured to control the pushing of the toothpaste a second button configured to turn on and turn off the electric toothbrush and switch a tooth-brushing mode.

15. (canceled)

16. The electric toothbrush according to claim 14, wherein the toothbrush head comprises:
a toothbrush rod having a hollow channel in communication with the hollow rotating shaft;
a rotating shaft bracket arranged inside the toothbrush rod and assembled with the hollow rotating shaft; and
a head provided with bristles, a one-way valve and a flexible rubber column, a liquid outlet space being formed between the flexible rubber column and the bristle, and the one-way valve being arranged between the liquid outlet spaces and in communication with the hollow channel; wherein an opening of the one-way valve is arranged longitudinally, the flexible rubber columns comprise an upper flexible rubber column and a lower flexible rubber column, the lower flexible rubber column is arranged closer to the toothbrush handle than the upper flexible rubber column, and a length of the upper flexible rubber column is smaller than a length of the lower flexible rubber column.

17. (canceled)

18. The electric toothbrush according to claim 14, wherein the toothpaste chamber comprises a cover, a first vial body, a first piston and a third sealing ring, the cover is in hermetic connection with the first vial body, the first piston abuts against the first vial body at an end away from the cover, and the third sealing ring is arranged between the first piston and the first vial body.

19. The electric toothbrush according to claim 14, wherein toothpaste chamber comprises:
a second vial body comprising a vial opening;
a chip arranged in the vial opening and configured to store information about the toothpaste in the toothpaste chamber; and
a second piston arranged in the second vial body and configured to push the toothpaste in the second vial body during the operation of the peristaltic pump.

20. (canceled)

21. The electric toothbrush according to claim 14, wherein the toothbrush handle comprises:
a housing on which a fastener is arranged;
a top cover provided with a slot adapted to the fastener, the top cover being coupled to the housing through the slot and the fastener; and
a waterproof sealing ring sleeved onto a joint between the housing and the top cover.

22. A control method, comprising:
transmitting a first control instruction to a peristaltic pump, the first control instruction being used to indicate the peristaltic pump to be in a working state for a first duration so as to push toothpaste in a toothpaste chamber to a toothbrush head; and
transmitting a second control instruction to a motor after the first duration, the second control instruction being used to indicate the motor to be in a working state for a second duration.

23. The control method according to claim 22, further comprising transmitting a third control instruction to a light plate, wherein the third control instruction is used to indicate the light plate to emit light in accordance with a predetermined strategy.

24.-26. (canceled)
